(19) United States
(12) Patent Application Publication
(10) Pub. No.: US 2024/0124678 A1
(43) Pub. Date: Apr. 18, 2024

(54) Full recovery, recycling and regenerative method for fabrics containing polyester fibers

(71) Applicants: Yanping Yu, Shanghai (CN); Xiaoxiao Ou, Shanghai (CN); Jiannan Li, Shanghai (CN)

(72) Inventors: Yanping Yu, Shanghai (CN); Xiaoxiao Ou, Shanghai (CN); Jiannan Li, Shanghai (CN)

(21) Appl. No.: 18/234,892

(22) Filed: Aug. 17, 2023

(30) Foreign Application Priority Data
Oct. 18, 2022 (CN) 202211275965.2

(51) Int. Cl. C08J 11/24; D01F 6/04; D01F 6/62; D01F 6/70

(52) U.S. Cl. CPC C08J 11/24; D01F 6/04; D01F 6/62; D01F 6/70; C08J 2323/00; C08J 2367/03; C08J 2375/04; D10B 2321/02; D10B 2331/04; D10B 2331/10

(57) ABSTRACT

A full recovery, recycling and regenerative method includes the polyester fibers being interwoven with elastic polyurethane fibers or elastic polyolefin fibers, or blended with regenerated cellulose fibers such as cotton, linen and viscose, by using titanium easily decomposed and recycled polyesters, and the complete separation of the fibers or blended fibers of the polyester fibers and the elastic fibers being achieved using the differences in chemical resistance and temperature resistance of various components. The polyester can be decomposed into small molecules under mild conditions of hydrolysis, alcoholysis and alkali hydrolysis. Under such mild conditions, the elastic polyurethane or elastic polyolefin fibers, or fibers such as the cotton, the linen, the viscose and nylon, are resistant to hydrolysis or alcohol, and will not decompose. The separation of the polyester fibers from other components is achieved. The other separated components are single loose components which can be recycled.

### BACKGROUND OF THE INVENTION

### 1. Field of the Invention

The invention relates to clothing fabrics and more particularly to a full recovery, recycling and regenerative method for fabrics containing polyester fibers.

### 2. Description of Related Art

Due to its excellent cost performance, the polyester fiber is currently the largest category of textile fiber, accounting for about 60% of the total fiber. The polyester fiber includes filaments and short fibers during use; and in order to meet different requirements for comfort and wearing scenes, the polymer fiber will be interwoven or blended with other fibers.

A large category of interweaving is interweaving with elastic fibers. At present, a spandex elastic fabric is mostly used for keeping the shape and wearing comfort of clothing, and polyester spandex fabrics interwoven with polyester fibers and spandex fibers are mostly used.

For the recycling of such fabrics and clothing, the fabric is a big problem. If a physical melting method is adopted, the two substances are mixed and cannot be separated; and if a chemical recovery is adopted, the chemical recovery of the polyester fiber is a high-concentration and high-temperature decomposition process, the spandex polyurethane is decomposed under conditions of hydrolysis, alkali hydrolysis, or alcoholysis; and under such chemical conditions, decomposition products of polyurethane are compatible with those of polyester, and these decomposition products cannot be separated from each other. However, the blending is that polyester short fibers are blended with regenerated cellulose fibers such as cotton, linen and viscose, so as to achieve the dryness of synthetic fibers and the comfort of cellulose fibers. The short fibers are widely applied, and include cotton, wool, hemp and filament of natural fibers as well as viscose, polyester, acrylic and nylon of chemical fibers. However, the short fibers must have a certain cohesion while spun, or the short fibers are twisted, or mixed and entangled, so that a short fiber yarn has a certain strength for weaving and using. Therefore, while the fibers are mixed, entangled and twisted, it brings the fabrics of the short fiber yarns and the difficulty of recycling regenerated short fibers. Because of the mixing, entanglement and twisting of the fibers, the recycled short fibers are difficult to be loosened and recycled; physical methods such as forced tearing or breaking make the fibers loose, but the obtained short fibers have been severely damaged, the length becomes shorter, the strength becomes smaller, the quality of recycled and regenerated fibers is reduced, and most of the use value is lost. For this kind of blending, the blending of ordinary polyester fibers and short fibers can be carried out by the chemical method. After the polyester is dissolved by the chemical method, other blended short fibers are separated. However, this chemical method requires long-term treatment with high temperature and high pressure or high concentration of chemical substances, which will seriously damage the strength and the length of other blended fibers. Therefore, this chemical method has no commercial value.

### SUMMARY OF THE INVENTION

In order to solve the above problems, the invention provides a full recovery, recycling and regenerative method for fabrics containing polyester fibers. In the invention, the fabrics containing the polyester fibers are interwoven with elastic polyurethane fibers or elastic polyolefin fibers, or blended with regenerated cellulose fibers such as cotton, linen, viscose, by using titanium easily decomposed and recycled polyesters, and complete separation and high-quality recovery of fibers or blended fibers of the polyester fibers and the elastic fibers are achieved using the differences in chemical resistance and temperature resistance of various components.

In order to achieve the above objective, the technical solution adopted in the invention is: a full recovery, recycling and regenerative method for fabrics containing polyester fibers, including the following steps of:
step I: hydrolyzing polyester interwoven fabric textiles at a high temperature or carrying out alcoholysis at a medium temperature or carrying out alkaline hydrolysis at a low temperature, and obtaining a decomposition mixture, where the polyester interwoven fabric textile is interwoven with titanium easily decomposed and recycled polyester fibers, elastic polyurethane fibers or elastic polyolefin fibers;
step II: separating decomposed polyester liquid, solid polyurethane or high-viscosity polyolefin liquid/solid polyolefin from the decomposition mixture, and separating the above two for separate storage for later use;
step III: performing high-temperature alcoholysis on the decomposed polyester liquid after hydrolysis or alcoholysis to obtain small molecule BHET (Polyethylene Terephthalate); after acid analysis of the decomposed polyester liquid upon alkaline hydrolysis, obtaining PTA (Purified Terephthalic Acid) after purification, and esterifying PTA with ethylene glycol to obtain small molecule BHET;
step IV: adding BHET to a reaction kettle, adding esterification liquid SSIPA (Monosodium 5-Sulfoisophthalate), a monomer A, rare earth oxide and a catalyst, and reacting under conditions of high temperature and high pressure to obtain a regenerated, easily decomposed and recycled polyester polymer;
step V: making the regenerated, easily decomposed and recycled polyester polymer to become regenerated, easily decomposed and recycled polyester fibers through a conventional polymerization process, melting and re-spinning;
step VI: ishing the solid polyurethane obtained in step II, and then obtaining the regenerated polyurethane elastic fibers through a conventional polyurethane spinning process; and step VII: ishing the high-viscosity polyolefin liquid/solid polyolefin obtained in step II after being cooled, and obtaining regenerated polyolefin elastic fibers through a conventional spinning process.

As a further preferred solution, at step I, the conditions of the high temperature alcoholysis are: temperature of 170-200° C., a ratio of fabric to ethylene glycol being 1: 2-12, a pressure of 0.3-2 MPA, and the time of 0.5-3 hour.

As a further preferred solution, at step I, the conditions of the middle temperature alcoholysis are: temperature of 150-180° C., a ratio of fabric to ethylene glycol being 1:4. a pressure of 0.1-0.5 MPA, and the time of 0.5-3 hour.

As a further preferred solution, at step I, the conditions of the low-temperature alkaline hydrolysis are: normal temperature of −150° C., a NaOH concentration of 3 g/L-40 g/L, a bath ratio of 1: 3-20, and time of 10 min-24 hour.

As a further preferred solution, at step IV, the BHET is added into the reaction kettle, the esterification liquid SSIPA and the monomer A are added, after stirring evenly, the rare earth oxide and the catalyst are added, reaction is carried out for 1-5 h under conditions of a temperature of 260-310° C., and an absolute pressure of 50-200 MPa, so as to obtain easily decomposed and recycled polyester polymer.

As a further preferred solution, at step IV, a preparation method for the esterification liquid SSIPA includes the following steps of: adding the monomer B and the ethylene glycol with a molar ratio of 1: 3-15 into the reaction kettle, adding 0.1-2% of acetate, stirring and heating up to 150-210° C., keeping the temperature for an esterification reaction, stopping the esterification reaction when an esterification rate reaches 50-95%, obtaining the esterification liquid SSIPA, and keeping the temperature for later use; the monomer B being sodium dimethyl 5-sulfonatoisophthalate (SIPM) or 5-sulfoisophthalic acid monosodium salt (SIPA).

As a further preferred solution, at step IV, a preparation method for the catalyst includes the following steps of:
(1) adding 1,2,4,5-cyclohexanetetracarboxylic dianhydride into an ethylene glycol solution, heating to 100-150° C. to fully dissolve the 1,2,4,5-cyclohexanetetracarboxylic dianhydride, slowly adding a titanium glycolate solution, heating to 110-180° C. until no water is released, and keeping the temperature for 4-12 h to obtain a solution A; where a mass ratio of the 1,2,4,5-cyclohexanetetracarboxylic dianhydride to the ethylene glycol solution to the titanium glycolate solution is 1:0.3-1.2:3-15;
(2) adding ethylene glycol, surfactant and boron nitride nanopowder in sequence, stirring at a high speed, grinding, and dispersing to obtain a mixture B; the surfactant being any one or a combination of polyvinyl alcohol, alkylbenzene sulfonate, fatty alcohol polyoxyethylene ether; an adding amount of the boron nitride nanopowder being 2-15% of the total weight of the solution, and an adding amount of the surfactant being 3-20% of the total weight of the solution;
(3) under the protection of a nitrogen atmosphere, dropping the mixture B to the solution A to obtain the catalyst; and a mass ratio of the solution A to the mixture B being 1:0.5-3.

As a further preferred solution, at step IV, the catalyst amount is 10-30 ppm.

As a further preferred solution, at step IV, the rare earth oxide is any one or a combination of lanthanum oxide, cerium oxide or yttrium oxide.

As a further preferred solution, at step IV, the amount of the rare earth oxide is 50-80 ppm.

As a further preferred solution, the ethylene glycol titanium solution in the step (1) is prepared by the following method: using anhydrous ethylene glycol and titanium tetrachloride as raw materials, in a closed environment, slowly adding titanium tetrachloride to excess anhydrous ethylene glycol in a stirring state, keeping stirring for 5-30 min, and introducing ammonia gas to neutralize hydrogen chloride produced by the reaction, stopping introduction of ammonia gas when a pH value of the solution is 7-8.5, standing still for 10-40 min, filtering to remove the precipitate, and obtaining the ethylene glycol titanium.

The invention further provides a full recovery, recycling and regenerative method for fabrics containing polyester fibers, including the following steps of:
step I: hydrolyzing the blended fabric textile or blended interwoven elastic textiles thereof at a high temperature, carrying out alcoholysis at a medium temperature or carrying out alkaline hydrolysis at a low temperature to obtain a decomposition mixture, where the blended fabric textile is blended by titanium easily decomposed recycled polyester fibers and short fibers; and the interwoven elastic fibers include elastic polyurethane fibers or elastic polyolefin fibers;
step II: separating decomposed polyester liquid from a decomposition mixture, recovering solid loose short fibers or containing solid elastic fibers, and separating the solid state from the liquid state and storing separately for later use, where the recovered solid short fibers includes any one or a combination of cotton and hemp short fibers, viscose polyester short fibers, viscose acrylic short fibers, and viscose nylon short fibers;
step III: carrying out high-temperature alcoholysis to decomposed polyester liquid after hydrolysis or alcoholysis to obtain small molecule BHET; after acid analysis of the decomposed polyester liquid upon alkaline hydrolysis, obtaining PTA after purification, and then esterifying PTA with ethylene glycol to obtain small molecule BHET;
step IV: adding BHET into a reaction kettle, adding esterification liquid SSIPA, a monomer A, rare earth oxide and a catalyst, and reacting under conditions of high temperature and high pressure to obtain a regenerated, easily decomposed and recycled polyester polymer;
step V: making the regenerated, easily decomposed and recycled polyester polymer to become regenerated, easily decomposed and recycled polyester fibers through a conventional polymerization process, melting and re-spinning;
step VI: for blended textiles, processing the recovered solid loose short fibers obtained in step II obtaining recycled shorts fibers through a conventional carding process; and after blending, separating the textiles interwoven with elastic fibers by airflow or carding to separate the blended short fibers from the interwoven elastic fibers; and
step VII: cleaning filament elastic fibers separated from the blended and then interwoven textiles in step VI, and obtaining regenerated elastic fibers through the conventional spinning process.

The regenerated, easily decomposed and recycled polyester fibers, regenerated elastic polyolefin fibers, regenerated elastic polyurethane fibers, and regenerated short fibers, such as cotton, linen and viscose can be used again, thereby realizing recycling and regeneration of textiles.

The beneficial effects of the invention are: in the invention, the fabrics containing the polyester fibers are interwoven with the elastic polyurethane fibers or the elastic polyolefin fibers, or blended with the regenerated cellulose fibers, such as the cotton, the linen, the viscose, using the titanium easily decomposed and recycled polyesters, and complete separation of the fibers or blended fibers of the polyester fibers and the elastic fibers is achieved using the differences in chemical resistance and temperature resistance of the various components.

The easily decomposed and recycled polyesters can be decomposed into small molecules under mild conditions of hydrolysis, alcoholysis and alkali hydrolysis; and under such mild conditions, the elastic polyurethane fibers or the elastic polyolefin fibers, or regenerated cellulose fibers such as the cotton, the linen and the viscose, are resistant to hydrolysis or alcohol and will not decompose. Thus, the separation of the polyester fibers from other components is achieved. The other components are single components and can also be recycled. That is, under the condition of lower temperature or chemical additives, the fabrics of the easily decomposed and recycled polyesters, interwoven or blended with other materials, are processed, so that the polyester fibers become liquid and are separated from other fibers; and the liquid decomposition products of the polyesters can be recovered according to the principle of reversibility of the reaction. In the fibers of other obtained components, the elastic fibers can be directly melt and spun into the regenerated elastic fibers; and the short fibers such as the cotton, the linen and the viscose are loose fiber polymers, and high-quality short fibers are easy to comb and recover.

The above and other objects, features and advantages of the invention will become apparent from the following detailed description taken with the accompanying drawings.

### BRIEF DESCRIPTION OF THE DRAWINGS

FIG. 1 is a table showing physical performance test results of fibers according to the invention; and

FIG. 2 is a table showing dyeing performance test results of fibers according to the invention.

### DETAILED DESCRIPTION OF THE INVENTION

### Example 1

A full recovery, recycling and regenerative method for fabrics containing polyester fibers of the invention comprises the following steps:
step I: interwoven textiles (the interwoven textiles are made of easily decomposed and recycled polyester filaments, elastic polyurethane fibers, or elastic polyolefin filament fibers) are hydrolyzed at a high temperature, and subjected to a solid-liquid separation, and a liquid phase and a solid phase thereof are taken for later use;
step II: decomposed polyester liquid, solid polyurethane or high-viscosity polyolefin liquid/solid polyolefin are separated from the decomposition mixture, and the liquid polyolefin is separated from the solid polyolefin for separate storage for later use;
step III: the decomposed polyester liquid after hydrolysis or alcoholysis is subjected to high-temperature alcoholysis to obtain small molecule BHET; and after acid analysis of the decomposed polyester liquid upon alkaline hydrolysis, PTA is obtained after purification, and PTA is esterified with ethylene glycol to obtain small molecule BHET; and
step IV: BHET is added to a reaction kettle, esterification liquid SSIPA, a monomer A, rare earth oxide and a catalyst are added, and reaction is carried out under conditions of high temperature and high pressure to obtain a regenerated, easily decomposed and recycled polyester polymer.

At step I, the conditions of the high temperature hydrolysis are: a temperature of 185° C., a weight ratio of fabric to water of 1:8, a pressure of 1.5 MPA and time of 2.5 hour. The easily decomposed polyester is decomposed into liquid under conditions of high temperature and hot water, while the polyurethane is still solid, so separation is achieved. If it is polyolefin, it is also liquid, but it is the high-viscosity liquid/solid polyolefin, which is incompatible with the liquid after the polyester is decomposed, and liquid separation could be achieved.

At step III, the liquid for decomposing the polyester through high temperature water is subjected to alcoholysis of ethylene glycol at a high temperature. Conditions are: a temperature of 197-220° C., a ratio of fabric to ethylene glycol of 1:4, a pressure of 0.1-0.5 MPA and time of 0.5-3 hour. and then small molecule BHET is obtained.

At step IV, BHET is into the reaction kettle, esterification liquid SSIPA and monomer A are added, after stirring evenly, rare earth oxide and catalyst are added, to react for 3 hour at a temperature of 285° C. and an absolute pressure of 120 MPa, and the easily decomposed recycled polyester polymer is obtained.

At step IV, the preparation method for the esterification liquid SSIPA comprises the following steps: the monomer B and the ethylene glycol with a molar ratio of 1:12 are added into the reaction kettle, 1.5% acetate is added to be stirred and heated up to 195° C., the temperature is kept for an esterification reaction, the esterification reaction stopped when an esterification rate reached 78%, and the esterification liquid SSIPA is obtained and kept warm for later use.

The monomer B is SIPM.

The total active ingredient SIPM of the esterification liquid SSIPA accounted for 7.2% by weight of PTA contained in the esterified product BHET, and the weight percentage of the monomer B accounting for PTA in the esterified product BHET is 11.5%;

At step IV, the catalyst amount is 18 ppm.

At step IV, the preparation method of the catalyst comprises the following steps:
(1) 1,2,4,5-cyclohexanetetracarboxylic dianhydride is added into an ethylene glycol solution, heated to 135° C. to fully dissolve the 1,2,4,5-cyclohexanetetracarboxylic dianhydride, a titanium glycolate solution is slowly added, heated to 170° C. until no water is released, it is kept the temperature for 8 h to obtain a solution A; and a mass ratio of the 1,2,4,5-cyclohexanetetracarboxylic dianhydride to the ethylene glycol solution and to the titanium glycolate solution is 1:1.1: 10;
(2) ethylene glycol, surfactant and boron nitride nanopowder are added in sequence, stirred at a high speed, ground, and dispersed to obtain a mixture B; the surfactant is polyvinyl alcohol; and an adding amount of the boron nitride nanopowder is 7.5% of the total weight of the solution, where an adding amount of the surfactant is 12% of the total weight of the solution; and
(3) under the protection of a nitrogen atmosphere, the mixture B is dropped to the solution A to obtain the catalyst; and a mass ratio of the solution A to the mixture B is 1:1.8.

The ethylene glycol titanium solution in the step (1) is prepared by the following method: anhydrous ethylene glycol and titanium tetrachloride are used as raw materials, in a closed environment, titanium tetrachloride is slowly added to excess anhydrous ethylene glycol in a stirring state, it is stirred for 20 min, and ammonia gas is introduced to neutralize hydrogen chloride produced by the reaction, introducing ammonia gas stopped when a pH value of the solution is 7.8, it stood still for 35 min, and is filtered to remove the precipitate, and the ethylene glycol titanium is obtained.

The mass fraction of a titanium element in the catalyst is 3.5%.

At step IV, the rare earth oxide is a mixture of lanthanum oxide and cerium oxide with a mass ratio of 1:1. The dosage of the rare earth oxide is 70 ppm.

### Example 2

A full recovery, recycling and regenerative method for fabrics containing polyester fibers of the invention comprises the following steps:
step I: interwoven textiles (the interwoven textiles are made of easily decomposed and recycled polyester filaments, elastic polyurethane fibers, or elastic polyolefin filament fibers) are subjected to alcoholysis using ethylene glycol at a middle temperature, and subjected to a solid-liquid separation, and a liquid phase and a solid phase thereof are taken for later use;
step II: decomposed polyester liquid, solid polyurethane or high-viscosity polyolefin liquid/solid polyolefin are separated from the decomposition mixture, and the liquid polyolefin is separated from the solid polyolefin for separate storage for later use;
step III: the decomposed polyester liquid after hydrolysis or alcoholysis is subjected to high-temperature alcoholysis to obtain small molecule BHET; and after acid analysis of the decomposed polyester liquid upon alkaline hydrolysis, PTA is obtained after purification, and PTA is esterified with ethylene glycol to obtain small molecule BHET; and
step IV: BHET is added to a reaction kettle, esterification liquid SSIPA, a monomer A, rare earth oxide and a catalyst are added, and reaction is carried out under conditions of high temperature and high pressure to obtain a regenerated, easily decomposed and recycled polyester polymer.

At step I, the conditions of the middle temperature alcoholysis are: a temperature of 170° C., a ratio of fabric to ethylene glycol of 1:4, a pressure of 0.25 MPA and time of 1.8 hour. The easily decomposed polyester is decomposed into liquid under conditions of middle temperature alcoholysis, while the polyurethane is still solid, so separation is achieved. The polyolefin is also liquid, but it is the high-viscosity liquid, which is incompatible with the liquid after the polyester is decomposed, and liquid separation could be achieved.

At step III, a heating temperature is 220° C., a ratio of fabric to ethylene glycol is 1:4, a pressure is 0.5 MPA and time is 3 hour. and then small molecule BHET is obtained.

In this specific example, at step IV, the BHET is into the reaction kettle, esterification liquid SSIPA and monomer A are added, after stirring evenly, rare earth oxide and catalyst are added, to react for 3.5 hour at a temperature of 285° C. and an absolute pressure of 120 MPa, and the easily decomposed recycled polyester polymer is obtained.

At step IV, the monomer A is a mixture of ethylene glycol and polyethylene glycol with a mass ratio of 1:2.

At step IV, the preparation method for the esterification liquid SSIPA comprises the following steps: the monomer B and the ethylene glycol with a molar ratio of 1:10 are added into the reaction kettle, 0.8% acetate is added to be stirred and heated up to 178° C., the temperature is kept for an esterification reaction, the esterification reaction stopped when an esterification rate reached 62%, and the esterification liquid SSIPA is obtained and kept the temperature for later use.

The monomer B is SIPM.

The total active ingredient SIPM of the esterification liquid SSIPA accounted for 8.8% by weight of PTA contained in the esterified product BHET, and the weight percentage of the monomer B accounting for PTA in the esterified product BHET is 6.5%; At step IV, the catalyst amount is 17 ppm.

At step IV, the preparation method of the catalyst comprises the following steps:
(1) 1,2,4,5-cyclohexanetetracarboxylic dianhydride is added into an ethylene glycol solution, heated to 125° C. to fully dissolve the 1,2,4,5-cyclohexanetetracarboxylic dianhydride, a titanium glycolate solution is slowly added, heated to 150θC until no water is released, it is kept warm for 9 h to obtain a solution A; and a mass ratio of the 1,2,4,5-cyclohexanetetracarboxylic dianhydride to the ethylene glycol solution and to the titanium glycolate solution is 1:0.9:4;
(2) ethylene glycol, surfactant and boron nitride nanopowder are added in sequence, stirred at a high speed, ground, dispersed to obtain a mixture B; the surfactant is polyvinyl alcohol; an adding amount of the boron nitride nanopowder is 9.5% of the total weight of the solution, and an adding amount of the surfactant is 11% of the total weight of the solution; and
(3) under the protection of a nitrogen atmosphere, the mixture B is dropped to the solution A to obtain the catalyst; and a mass ratio of the solution A to the mixture B is 1:1.8.

The ethylene glycol titanium solution in the step (1) is prepared by the following method: anhydrous ethylene glycol and titanium tetrachloride are used as raw materials, in a closed environment, titanium tetrachloride is slowly added to excess anhydrous ethylene glycol in a stirring state, it is stirred for 25 min, and ammonia gas is introduced to neutralize hydrogen chloride produced by the reaction, introducing ammonia gas is stopped when a pH value of the solution is 7.4, it stood still for 25 min, is filtered to remove the precipitate, and the ethylene glycol titanium is obtained.

The mass fraction of a titanium element in the catalyst is 4.5%.

At step IV, the rare earth oxide is lanthanum oxide. The dosage of the rare earth oxide is 80 ppm.

### Example 3

A full recovery, recycling and regenerative method for fabrics containing polyester fibers of the invention comprises the following steps:
step I: interwoven textiles (the interwoven textiles are blended with easily decomposed and recycled polyester short fibers, and interwoven with elastic polyurethane fibers) are subjected to alkaline hydrolysis using NaOH at a low temperature, and subjected to a solid-liquid separation, and a liquid phase and a solid phase thereof are taken for later use;
step II: the liquid phase processed in step I included decomposed polyester liquid;
step III: the dissolved decomposed polyester liquid is decomposed through low temperature and low alkaline, the temperature is 100° C., after sulfuric acid acidification, oligomers PET, terephthalic acid, ethylene glycol are obtained, and oligomers and terephthalic acid are obtained after filtering the ethylene glycol; the product is subjected to high-temperature alcoholysis, with a temperature of 205° C., a ratio of fabric to ethylene glycol of 1:4, a pressure of 0.2 MPA and time of 1.5 h; and then small molecule BHET is obtained; and
step IV: BHET is added to a reaction kettle, esterification liquid SSIPA, a monomer A, rare earth oxide and a catalyst are added, and reaction is carried out under conditions of high temperature and high pressure to obtain a regenerated, easily decomposed and recycled polyester polymer.

In this specific example, at step I, the conditions are: a normal temperature, a NaOH concentration of 40 g/L, a bath ratio of 1: 3-20, and time of 24 hour. The easily decomposed polyester is decomposed into liquid under the action of NaOH; other elastic fiber polyurethanes are fibrous solids, and the liquid and solid are separated from each other after filtration.

At step IV, BHET is added into the reaction kettle, the esterification liquid SSIPA and monomer A are added, stirred evenly, rare earth oxide and catalyst are added, and reaction is carried out for 5 hour at a temperature of 310° C. and an absolute pressure of 50 MPa, and the easily decomposed recycled polyester polymer is obtained.

At step IV, the monomer A is polyethylene glycol monomethyl ether.

At step IV, the preparation method of the esterification liquid SSIPA comprises the following steps: the monomer B and the ethylene glycol with a molar ratio of 1:15 are added into the reaction kettle, 0.1% potassium acetate is added, stirred and heated to 210° C., the temperature is kept to carry out the esterification reaction, the esterification reaction stopped when the esterification rate reached 50%, the esterification solution SSIPA is obtained, kept the temperature for later use.

The monomer B is SIPM.

The total active ingredient SIPM of the esterification liquid SSIPA accounts for 15% by weight of PTA contained in the esterified product BHET, and the weight percentage of the monomer B accounting for PTA in the esterified product BHET is 2%;

At step IV, the catalyst amount is 30 ppm.

At step IV, the preparation method of the catalyst comprises the following steps:
1,2,4,5-cyclohexanetetracarboxylic dianhydride is added into an ethylene glycol solution, heated to 100° C. to fully dissolve the 1,2,4,5-cyclohexanetetracarboxylic dianhydride, a titanium glycolate solution is slowly added, heated to 180° C. until no water is released, it is kept the temperature for 4 h to obtain a solution A; and a mass ratio of the 1,2,4,5-cyclohexanetetracarboxylic dianhydride to the ethylene glycol solution to the titanium glycolate solution is 1:1.2:3;
ethylene glycol, surfactant and boron nitride nanopowder are added in sequence, stirred at a high speed, ground, dispersed to obtain a mixture B; the surfactant is a mixture of polyvinyl alcohol and fatty alcohol polyoxyethylene ether with a mass ratio of 3:1, an adding amount of the boron nitride nanopowder is 15% of the total weight of the solution, and an adding amount of the surfactant is 3% of the total weight of the solution; and
under the protection of a nitrogen atmosphere, the mixture B is dropped to the solution A to obtain the catalyst; and a mass ratio of the solution A to the mixture B is 1:3;

The ethylene glycol titanium solution in the step (1) is prepared by the following method: anhydrous ethylene glycol and titanium tetrachloride are used as raw materials, in a closed environment, titanium tetrachloride is slowly added to excess anhydrous ethylene glycol in a stirring state, it is stirred for 5 min, and ammonia gas is introduced to neutralize hydrogen chloride produced by the reaction, introducing ammonia gas stopped when a pH value of the solution is 8.5, it stood still for 10 min, is filtered to remove the precipitate, and the ethylene glycol titanium is obtained. The mass fraction of a titanium element in the catalyst is 8%.

At step IV, the rare earth oxide is cerium oxide. The dosage of the rare earth oxide is 55 ppm.

### Example 4

A full recovery, recycling and regenerative method for fabrics containing polyester fibers of the invention comprises the following steps:
step I: the blended fabric textiles are hydrolyzed at a high temperature to obtain a decomposition mixture, where the blended fabric textile is formed by blending easily decomposed and recycled polyester short fibers and other short fibers;
step II: the liquid phase processed in step 1 included mutually immiscible decomposed polyester liquid and high-viscosity/solid polyolefin liquid, or solid polyurethane, and the they are separated and stored separately for later use;
step III: the decomposed polyester liquid is heated again, and ethylene glycol is added at the same time to obtain small molecule BHET;
step IV: BHET is added into the reaction kettle, the esterification liquid SSIPA, monomer A, rare earth oxide and catalyst are added, and reaction is carried out under conditions of high temperature and high pressure to obtain easily decomposed and recycled polyester polymer.

In this specific example, at step I, the conditions of the high temperature hydrolysis are: a temperature of 185° C., a weight ratio of fabric to water of 1:8, a pressure of 1.5 MPA and time of 2.5 hour.

In this specific example, at step III, the liquid for decomposing the polyester by high temperature water is subjected to high temperature and alcoholysis of ethylene glycol. The conditions are a temperature of 197-220° C., a ratio of fabric to ethylene glycol of 1:4, a pressure of 0.1-0.5 MPA and time of 0.5-3 hour, and small molecule BHET is obtained.

At step IV, BHET is added into the reaction kettle, esterification liquid SSIPA and monomer A are added, stirred evenly, and rare earth oxide and catalyst are added; and reaction is carried out for 1 hour at a temperature of 260° C. and an absolute pressure of 200 MPa, and easily decomposed recycled polyester polymer is obtained.

At step IV, the monomer A is polyethylene glycol.

At step IV, the preparation method of the esterification liquid SSIPA comprises the following steps: the monomer B and ethylene glycol with a molar ratio of 1:3 are added into the reaction kettle, 2% sodium acetate is added, stirred and heated to 150° C., the temperature is kept to carry out the esterification reaction; when the esterification rate reached 95%, the esterification reaction stopped, the esterification solution SSIPA is obtained, kept the temperature for later use.

The monomer B is SIPM.

The total active ingredient SIPM of the esterification liquid SSIPA accounted for 1% by weight of PTA contained in the esterified product BHET, and the weight percentage of the monomer B accounting for PTA in the esterified product BHET is 20%.

At step IV, the catalyst amount is 10 ppm.

At step IV, the preparation method of the catalyst comprises the following steps:
1,2,4,5-cyclohexanetetracarboxylic dianhydride is added into an ethylene glycol solution, heated to 150° C. to fully dissolve the 1,2,4,5-cyclohexanetetracarboxylic dianhydride, a titanium glycolate solution is slowly added, heated to 110° C. until no water is released, the temperature is kept for 12 h to obtain a solution A; and a mass ratio of the 1,2,4,5-cyclohexanetetracarboxylic dianhydride to the ethylene glycol solution and to the titanium glycolate solution is 1:0.3:15;
ethylene glycol, surfactant and boron nitride nanopowder are added in sequence, stirred at a high speed, ground, dispersed to obtain a mixture B; the surfactant is any one or a combination of polyvinyl alcohol, alkylbenzene sulfonate, fatty alcohol polyoxyethylene ether; an adding amount of the boron nitride nanopowder is 2% of the total weight of the solution, and an adding amount of the surfactant is 20% of the total weight of the solution; and
under the protection of a nitrogen atmosphere, the mixture B is dropped to the solution A to obtain the catalyst; and a mass ratio of the solution A to the mixture B is 1:0.5.

The ethylene glycol titanium solution in the step (1) is prepared by the following method: anhydrous ethylene glycol and titanium tetrachloride are used as raw materials, in a closed environment, titanium tetrachloride is slowly added to excess anhydrous ethylene glycol in a stirring state, it is stirred for 30 min, and ammonia gas is introduced into neutralize hydrogen chloride produced by the reaction, introducing ammonia gas is stopped when a pH value of the solution is 7.0, it stood still for 40 min, is filtered to remove the precipitate, and the ethylene glycol titanium is obtained.

The mass fraction of a titanium element in the catalyst is 0.5%.

At step IV, the rare earth oxide is a mixture of lanthanum oxide, cerium oxide or yttrium oxide with a mass ratio of 1:1:1. The dosage of the rare earth oxide is 65 ppm.

### Example 5

A full recovery, recycling and regenerative method for fabrics containing polyester fibers of the invention comprises the following steps:
step I: the blended fabric textiles are hydrolyzed at a middle temperature to obtain a decomposition mixture, where the blended fabric textile is formed by blending easily decomposed and recycled polyester short fibers and other short fibers;
step II: the liquid phase processed in step 1 included mutually immiscible decomposed polyester liquid and high-viscosity/solid polyolefin liquid, or solid polyurethane, and the they are separated and stored separately for later use;
step III: the decomposed polyester liquid is heated again, and ethylene glycol is added at the same time to obtain small molecule BHET; and
step IV: BHET is added into the reaction kettle, the esterification liquid SSIPA, monomer A, rare earth oxide and catalyst are added, and reaction is carried out under conditions of high temperature and high pressure to obtain easily decomposed and recycled polyester polymer.

In this specific example, at step I, the conditions are: a temperature of 150-180° C., a ratio of fabric to ethylene glycol of 1:4, a pressure of 0.1-0.5 MPA and time of 0.5-3 hour.

In this specific example, at step III, the polyester liquid decomposed at a middle temperature of 150-180° C. is subjected to high-temperature alcoholysis again, with a temperature of 197-220° C., a ratio of fabric to ethylene glycol of 1:4, a pressure of 0.1-0.5 MPA, and time of 0.5-3 hour, and small molecule BHET is obtained.

At step IV, BHET is added into the reaction kettle, esterification liquid SSIPA and monomer A are added, stirred evenly, and rare earth oxide and catalyst are added; and reaction is carried out for 2.5 hour at a temperature of 260° C. and an absolute pressure of 120 MPa, and easily decomposed recycled polyester polymer is obtained.

At step IV, the monomer A is ethylene glycol.

At step IV, the preparation method of the esterification liquid SSIPA comprises the following steps: the monomer B and ethylene glycol with a molar ratio of 1:10 are added into the reaction kettle, 1.2% sodium acetate is added, stirred and heated to 175° C., the temperature is kept to carry out the esterification reaction; when the esterification rate reached 65%, the esterification reaction stopped, the esterification solution SSIPA is obtained, the temperature is kept for later use.

The monomer B is SIPM.

The total active ingredient SIPM of the esterification liquid SSIPA accounted for 3% by weight of PTA contained in the esterified product BHET, and the weight percentage of the monomer B accounting for PTA in the esterified product BHET is 15%;

At step IV, the catalyst amount is 12 ppm.

At step IV, the preparation method of the catalyst comprises the following steps:
1,2,4,5-cyclohexanetetracarboxylic dianhydride is added into an ethylene glycol solution, heated to 150° C. to fully dissolve the 1,2,4,5-cyclohexanetetracarboxylic dianhydride, a titanium glycolate solution is slowly added, heated to 145° C. until no water is released, it is kept warm for 8 h to obtain a solution A; and a mass ratio of the 1,2,4,5-cyclohexanetetracarboxylic dianhydride to the ethylene glycol solution and to the titanium glycolate solution is 1:0.8:12;
ethylene glycol, surfactant and boron nitride nanopowder are added in sequence, stirred at a high speed, ground, dispersed to obtain a mixture B; the surfactant is polyvinyl alcohol; an adding amount of the boron nitride nanopowder is 5% of the total weight of the solution, and an adding amount of the surfactant is 15% of the total weight of the solution; and
under the protection of a nitrogen atmosphere, the mixture B is dropped to the solution A to obtain the catalyst; and a mass ratio of the solution A to the mixture B is 1:2.4.

The ethylene glycol titanium solution in the step (1) is prepared by the following method: anhydrous ethylene glycol and titanium tetrachloride are used as raw materials, in a closed environment, titanium tetrachloride is slowly added to excess anhydrous ethylene glycol in a stirring state, it is stirred for 25 min, and ammonia gas is introduced to neutralize hydrogen chloride produced by the reaction, introducing ammonia gas stopped when a pH value of the solution is 7.5, it stood still for 35 min, is filtered to remove the precipitate, and the ethylene glycol titanium is obtained.

The mass fraction of a titanium element in the catalyst is 2%.

At step IV, the rare earth oxide is a mixture of lanthanum oxide and yttrium oxide with a mass ratio of 1:3. The dosage of the rare earth oxide is 80 ppm.

### Example 6

A full recovery, recycling and regenerative method for fabrics containing polyester fibers comprises the following steps:
step I: the blended fabric textiles are subjected to alkaline hydrolysis at a low temperature to obtain a decomposition mixture, where the blended fabric textile is formed by blending easily decomposed and recycled polyester short fibers and other short fibers;
step II: the decomposed polyester liquid and the recycled solid short fibers are recycled from the decomposed mixture, and they are separated and stored separately for later use, where the recycled solid short fibers included short fibers such as cotton, linen, viscose, nylon, etc.;
step III: the decomposed polyester liquid after low-temperature alkali decomposition and dissolution is subjected to sulfuric acid analysis to obtain oligomers PET, terephthalic acid, and ethylene glycol. After filtering the ethylene glycol, the decomposition liquid of the oligomers and the terephthalic acid is obtained, and the decomposed polyester liquid is subjected to high-temperature alcoholysis to obtain small molecule BHET; and
step IV: BHET is added into the reaction kettle, esterification liquid SSIPA, monomer A, rare earth oxide and catalyst are added, and reaction is carried under conditions of high temperature and high pressure to obtain easily decomposed and recycled polyester polymer.

In this specific example, at step I, the temperature: 100° C.-room temperature, NaOH concentration: 3 g/L-40 g/L, bath ratio: 1: 3-20, and time: 10 min-24 hour. The easily decomposable polyester is decomposed into liquid under the action of NaOH; and other short fibers are also solid, and the liquid and solid are separated from each other after filtration.

In this specific example, at step III, after the polyester is decomposed and dissolved under conditions of low temperature and low alkali and after H2SO4 acid analysis, the oligomer PET, terephthalic acid, ethylene glycol, etc. are obtained; and after filtering the ethylene glycol, the oligomer and terephthalic acid are obtained; the product is subjected to high-temperature alcoholysis, with a temperature of 197-220° C., a ratio of fabric to ethylene glycol being 1:4, a pressure of 0.1-0.5 MPA and time of 0.5-3 hour, and small molecule BHET is obtained.

At step IV, BHET is added into the reaction kettle, esterification liquid SSIPA and monomer A are added, and after stirred evenly, rare earth oxide and catalyst are added, and reaction is carried out for 3.5 hour at a temperature of 280° C. and an absolute pressure of 120 MPa, and easily decomposed recycled polyester polymer is obtained.

At step IV, the monomer A is polyethylene glycol.

At step IV, the preparation method of the esterification liquid SSIPA comprises the following steps: the monomer B and ethylene glycol with a molar ratio of 1:8 are added into the reaction kettle, 0.8% sodium acetate is added, stirred and heated to 195° C., the temperature is kept to carry out the esterification reaction; when the esterification rate reached 77%, the esterification reaction stopped, the esterification solution SSIPA is obtained, kept warm for later use.

The monomer B is SIPM.

The total active ingredient SIPM of the esterification liquid SSIPA accounted for 10% by weight of PTA contained in the esterified product BHET, and the weight percentage of the monomer B accounting for PTA in the esterified product BHET is 5%;

At step IV, the catalyst amount is 20 ppm.

At step IV, the preparation method of the catalyst comprises the following steps:
1,2,4,5-cyclohexanetetracarboxylic dianhydride is added into an ethylene glycol solution, heated to 135° C. to fully dissolve the 1,2,4,5-cyclohexanetetracarboxylic dianhydride, a titanium glycolate solution is slowly added, heated to 155° C. until no water is released, it is kept warm for 10 h to obtain a solution A; and a mass ratio of the 1,2,4,5-cyclohexanetetracarboxylic dianhydride to the ethylene glycol solution and to the titanium glycolate solution is 1:0.8:12;
ethylene glycol, surfactant and boron nitride nanopowder are added in sequence, stirred at a high speed, ground, dispersed to obtain a mixture B; the surfactant is fatty alcohol polyoxyethylene ether; an adding amount of the boron nitride nanopowder is 10% of the total weight of the solution, and an adding amount of the surfactant is 10% of the total weight of the solution; and
under the protection of a nitrogen atmosphere, the mixture B is dropped to the solution A to obtain the catalyst; and a mass ratio of the solution A to the mixture B is 1:1.2.

The ethylene glycol titanium solution in the step (1) is prepared by the following method: anhydrous ethylene glycol and titanium tetrachloride are used as raw materials, in a closed environment, titanium tetrachloride is slowly added to excess anhydrous ethylene glycol in a stirring state, it is stirred for 8 min, and ammonia gas is introduced to neutralize hydrogen chloride produced by the reaction, introducing ammonia gas stopped when a pH value of the solution is 7.4, it stood still for 30 min, is filtered to remove the precipitate, and the ethylene glycol titanium is obtained.

The mass fraction of a titanium element in the catalyst is 5%.

At step IV, the rare earth oxide is yttrium oxide. The dosage of the rare earth oxide is 68 ppm.

### Comparison Example 1

The rare earth oxide in example 1 is replaced with lanthanum oxide, the amount of the rare earth oxide remained unchanged, and the remaining proportions and preparation methods remained unchanged.

### Comparison Example 2

The rare earth oxide in example 1 is replaced with cerium oxide, the amount of the rare earth oxide remained unchanged, and the remaining proportions and preparation methods remained unchanged.

### Comparison Example 3

The rare earth oxide in example 1 is replaced with yttrium oxide, the amount of the rare earth oxide remained unchanged, and the remaining proportions and preparation methods remained unchanged.

### Comparison Example 4

The rare earth oxide in example 1 is replaced with a mixture of lanthanum oxide, cerium oxide and yttrium oxide with a mass ratio of 1:1:1, the amount of the rare earth oxide remained unchanged, and the remaining proportions and preparation methods remained unchanged.

### Comparison Example 5

The rare earth oxide in example 1 is replaced with a mixture of cerium oxide and yttrium oxide with a mass ratio of 1:1, the amount of the rare earth oxide remained unchanged, and the remaining proportions and preparation methods remained unchanged.

### Comparison Example 6

The rare earth oxide in example 1 is replaced with an equivalent amount of zinc oxide, and the remaining proportions and preparation methods remained unchanged.

### Example 7: Preparation of Easily Decomposed and Recycled Fibers

The easily decomposed and recycled polyester polymers prepared in examples 1-6 and Comparison examples 1-6 are melted at 285° C. respectively, and the melts are sent into a spinneret assembly; and after the melt passed through the spinneret assembly, atomization spray is adopted to cool primary yarns rapidly. The melts are continued to draw through a hot roller, after the drawn by the hot roller and before winding, atomization spray is carried out to cool and shape the fibers, POY filaments are prepared, and the shaped POY filaments are prepared into DTY filaments through a conventional drawing and crimping process, where the atomization spray is gaseous water at a room temperature, with a relative humidity of 100%.

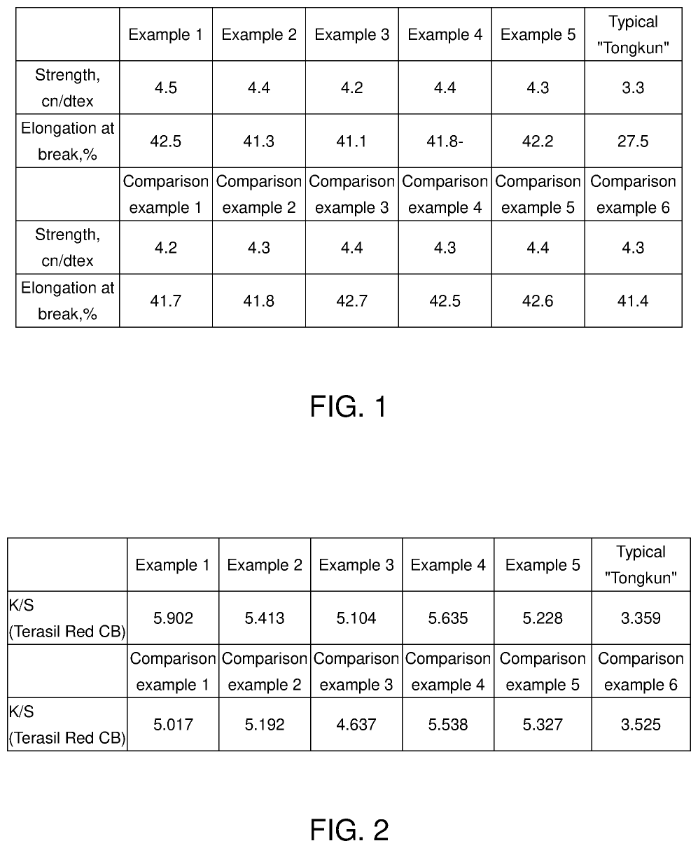

The physical properties of the filaments prepared in example 7 and typical filaments are tested, and the strength and elongation at break of the fibers are tested as shown in physical performance test results of fibers of FIG. 1.

Among them, the strength test of the fiber adopts the national standard GB/T 14344-2008 Testing Method for Tensile of Man-made Filament Yarns.

Specification: filaments of easily decomposed and recycled polymers: DTY, 75D/36F; typical: “Tongkun” polyester fiber filament, DTY 75D/36F.

It can be seen from the performance test results that the strength performance of the recycled fiber prepared by the invention can meet the performance requirements of fiber spinning.

The dyeing performances of the filaments prepared in example 7 and typical filaments are tested, and the K/S value of the fibers is tested, as shown in dyeing performance test results of fibers of FIG. 2.

The test method is as follows: in a dye solution with a dye concentration of 3% owf, a phenyl acrylate concentration of 8% v/v, a hydrogen peroxide concentration of 4% v/v, a penetrating agent JFC dosage of 1 g/L, a leveling dosage of 2 g/L, a liquor ratio of 15:1, and a pH=5.5, the fibers are dyed at 120° C., and then the fibers are shed thoroughly after dyeing. The K/S value of the fiber is measured with a Datacolor Spectraflash plus. In order to reduce the test error, 5 points of each test sample are taken to measure K/S values respectively, and an average value is taken.

It can be seen from the above test data that the dyeing performance of the recycled fibers prepared by the invention is significantly enhanced due to the addition of rare earth oxides.

While the invention has been described in terms of preferred embodiments, those skilled in the art will recognize that the invention can be practiced with modifications within the spirit and scope of the appended claims.

What is claimed is:

1. A full recovery, recycling and regenerative method for fabrics containing polyester fibers, comprising the steps of:
(1) hydrolyzing polyester interwoven fabric textiles at a high temperature or carrying out alcoholysis at a medium temperature or carrying out alkaline hydrolysis at a low temperature, and obtaining a decomposition mixture, wherein the polyester interwoven fabric textile is interwoven with titanium easily decomposed and recycled polyester fibers, elastic polyurethane fibers or elastic polyolefin fibers;
(2) separating decomposed polyester liquid, solid polyurethane or high-viscosity polyolefin liquid/solid polyolefin from the decomposition mixture, and separating the liquid polyolefin from the solid polyolefin for separate storage for later use;
(3) performing high-temperature alcoholysis on the decomposed polyester liquid after hydrolysis or alcoholysis to obtain small molecule BHET (Polyethylene Terephthalate); and after acid analysis of the decomposed polyester liquid upon alkaline hydrolysis, obtaining PTA (Purified Terephthalic Acid) after purification, and esterifying PTA with ethylene glycol to obtain small molecule BHET;
(4) adding BHET to a reaction kettle, adding esterification liquid SSIPA, a monomer A, rare earth oxide and a catalyst, and reacting under conditions of high temperature and high pressure to obtain a regenerated, easily decomposed and recycled polyester polymer;
(5) the regenerated, easily decomposed and recycled polyester polymer becoming regenerated, easily decomposed and recycled polyester fibers through a conventional polymerization process, melting and re-spinning;
(6) washing the solid polyurethane obtained in step II, and then obtaining the regenerated polyurethane elastic fibers through a conventional polyurethane spinning process; and
(7) washing the high-viscosity polyolefin liquid/solid polyolefin obtained in step II after being cooled, and obtaining regenerated polyolefin elastic fibers through a conventional spinning process.

2. The full recovery, recycling and regenerative method for fabrics containing polyester fibers of claim 1, wherein at step (1) the conditions of the high temperature hydrolysis are: a temperature of 170-200° C., a weight ratio of fabric to water of 1: 2-12, a pressure of 0.3-2 MPA, and time of 0.5-3 hour.

3. The full recovery, recycling and regenerative method for fabrics containing polyester fibers of claim 1, wherein at step (1) the conditions of the medium temperature alcoholysis are: a temperature of 150-180° C., a ratio of fabric to ethylene glycol of 1:4, a pressure of 0.1-0.5 MPA, and time of 0.5-3 hour.

4. The full recovery, recycling and regenerative method for fabrics containing polyester fibers of claim 1, wherein at step (1) the conditions of the low-temperature alkaline hydrolysis are: a normal temperature of −150° C., a NaOH concentration of 3 g/L-40 g/L, a bath ratio of 1: 3-20, and time of 10 min-24 hour.

5. The full recovery, recycling and regenerative method for fabrics containing polyester fibers of claim 1, wherein at step (4) BHET is added into the reaction kettle, the esterification liquid SSIPA (Monosodium 5-Sulfoisophthalate) and the monomer A are added; and after stirring evenly, the rare earth oxide and the catalyst are added to react for 1-5 hour at a temperature of 260-310° C. and an absolute pressure of 50-200 MPa, so as to obtain the easily decomposed and recycled polyester polymer.

6. The full recovery, recycling and regenerative method for fabrics containing polyester fibers of claim 1, wherein at step (4) the rare earth oxide is any one or a combination of lanthanum oxide, cerium oxide or yttrium oxide.

7. The full recovery, recycling and regenerative method for fabrics containing polyester fibers of claim 1, wherein at step (4) the amount of the rare earth oxide is 50-80 ppm.

8. A full recovery, recycling and regenerative method for fabrics containing polyester fibers, comprising the steps of:
step I: hydrolyzing the blended fabric textile or blended interwoven elastic textiles thereof at a high temperature, and carrying out alcoholysis at a medium temperature or carrying out alkaline hydrolysis at a low temperature to obtain a decomposition mixture, wherein the blended fabric textile is blended by titanium easily decomposed recycled polyester fibers and short fibers; and the interwoven elastic fibers comprise elastic polyurethane fibers or elastic polyolefin fibers;
step II: separating decomposed polyester liquid from a decomposition mixture, recovering solid loose short fibers or containing solid elastic fibers, and separating the solid state from the liquid state and storing separately for later use, wherein the recovered solid short fiber comprises any one or a combination of cotton and hemp short fiber, viscose polyester short fiber, viscose acrylic short fiber, and viscose nylon short fiber;
step III: performing high-temperature alcoholysis to decomposed polyester liquid after hydrolysis or alcoholysis to obtain small molecule BHET; after acid analysis of the decomposed polyester liquid upon alkaline hydrolysis, obtaining PTA after purification, and then esterifying PTA with ethylene glycol to obtain small molecule BHET;
step IV: adding BHET into a reaction kettle, adding esterification liquid SSIPA, a monomer A, rare earth oxide and a catalyst, and reacting under conditions of high temperature and high pressure to obtain a regenerated, easily decomposed and recycled polyester polymer;
step V: the regenerated, easily decomposed and recycled polyester polymer becoming regenerated, easily decomposed and recycled polyester fibers through a conventional polymerization process, melting and re-spinning;
step VI: for blended textiles, the recovered solid loose short fibers obtained in step II obtaining recycled shorts fibers through a conventional carding process; and after blending, separating the textiles interwoven with elastic fibers by airflow or carding to separate the blended short fibers from the interwoven elastic fibers; and
step VII: cleaning filament elastic fibers separated from the blended and then interwoven textiles in step VI, and obtaining the regenerated elastic fibers through the conventional spinning process.
